(19) United States
(12) Patent Application Publication
(10) Pub. No.: US 2014/0164242 A1
(43) Pub. Date: Jun. 12, 2014

(54) Controlling Accounts of Online Transaction Platform

(71) Applicant: Alibaba Group Holding Limited, Grand Cayman (KY)

(72) Inventor: Tianpeng Lei, Hangzhou (CN)

(73) Assignee: Alibaba Group Holding Limited, Grand Cayman (KY)

(21) Appl. No.: 14/098,099

(22) Filed: Dec. 5, 2013

(30) Foreign Application Priority Data
Dec. 10, 2012 (CN) 201210530382.X

(51) Int. Cl. G06Q 20/40

(52) U.S. Cl. CPC G06Q 20/40
USPC 705/44

(57) ABSTRACT

The present disclosure provides an example method, apparatus, and server for controlling accounts of an online transaction platform. Leveled control functions are provided to a user account. Functions provided to the user account are classified into at least two levels. Each level may include one or more functions and each level corresponds to respective security verification. The leveled control functions or authorizations are initiated for the user account. When the user account is used to log-in subsequently, a request for opening a level of the user account is received. If the user account passes a security verification corresponding to the requested level, functions of the requested level are opened to the user account. An opening status of the opened level is maintained until the user account logs off a system or the opened level is closed to the user account.

### CROSS REFERENCE TO RELATED PATENT APPLICATIONS

This application claims foreign priority to Chinese Patent Application No. 201210530382.X filed on 10 Dec. 2012, entitled “Method, Apparatus, and Server for Controlling Accounts of Online Transaction Platform,” which is hereby incorporated by reference in its entirety.

### TECHNICAL FIELD

The present disclosure relates to the field of network technology, and more specifically, to a method, an apparatus, and a server for controlling accounts of online transaction platform.

### BACKGROUND

A transaction administration platform provides suitable individualized security products (such as products different from operation protection functions of Taobao™) to merchants to implement secured log-in supervision and control. The biggest difference between a buyer and a seller in a transaction is that the buyer is usually an individual while most sellers are companies in addition to some individuals. The transaction scenario and privilege administration are relatively complicated for sellers. Thus, characteristics of the security products shall satisfy the needs of most sellers who are companies.

The conventional double verification product, such as the operation protection of Taobao™, requires using a short message of a cell phone, one-time password (OTP) or dynamic password to conduct identity verification when a user logs in or conducts an important business operation to ensure that the user is an account owner. However, such products are not suitable for the security requirements and experiences of the sellers that are companies and their application scenarios are not individualized for a particular seller.

The conventional platform-level merchant account security administration cannot achieve a company-level control and is limited by an overall account control process of the website, cannot individually satisfy an administration status of the particular company, and cannot find a balance between a secured log-in administration and a privilege separation. An example merchant may have three sub-accounts A, B, and C. A is responsible for after-sale services. B is responsible for services prior to a sale and only needs communication through instant communication (IM). C is responsible for finance relating to capital management. Each sub-account controls its own log-in and security. If A is hacked or an employee controlling A leaves the merchant, the merchant will have the risk of leaking information and losing capital from its account due to a lack of a use right and a controlling right of the account.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method, an apparatus, and a server for controlling accounts of an online transaction platform that provides a differentiated account control mechanism.

The present disclosure provides an example method for controlling accounts of the online transaction platform.

Leveled control functions are provided to a user account. Functions provided to the user account are classified into at least two levels. Each level may provide or include one or more functions and each level corresponds to respective security verification.

The leveled control functions or authorizations are initiated for the user account.

When the user account is used to log in subsequently, a request for opening a level to the user account is received. If the user account passes a security verification corresponding to the requested level, functions of the requested level are opened to the user account. An opening status of the opened level is maintained until the user account logs off a system or the opened level is closed to the user account.

The example method may further include the following characteristics and use the following approaches to open the leveled control functions to the user account.

When the user account satisfies a first condition, after the request for opening the leveled control functions from the user account is received, a security verification corresponding to the leveled control functions is applied to the user account. If the user account passes the security verification, the leveled control functions are opened to the user account.

The example method may also include the following characteristics. The security verification corresponding to the leveled control functions may include personal information verification.

The example method may also include the following characteristics and authorize the user account as follows.

When the user account satisfies a second condition, after a request for authorizing the user account is received, such request is forwarded to a controlling party of the user account. Security verification related information sent by the controlling party to the user account is received and such security verification related information is forwarded to the user account. Responding information relating to the security verification related information returned by the user account is received. Whether the user account passes the verification is determined based on the responding information. If the user account passes the verification, the user account is authorized.

The example method may also include the following characteristics. The security verification related information may include a security question or a combination of the security question and a verification code. The responding information may include an answer to the security question or a combination of the answer to the question and the verification code.

The example method may also include the following characteristics. The levels may include a first level and a second level. The second level may be requested for initiation only after the first level is initiated.

When the user account is used to log in subsequently, a request for opening a level for the user account is received. If the user account passes the security verification corresponding to the requested level, functions of the requested level are opened to the user account. For example, after a log-in request from the user account is received, an identity verification for log-in is conducted. If the user account passes the identity verification, the functions of the first level are opened to the user account. The opening status of the first level is maintained until the user account logs off the system. When a request for opening the second level for the user account is received, a security verification corresponding to the second level is conducted. If the user account passes the security verification corresponding to the second level, functions of the second level are opened to the user account. The opening status of the second level is maintained until the user account logs off the system.

The example method may also include the following characteristics. The levels may further include a third level. The third level may be requested for opening only after the second level is opened. For example, after functions of the third level are opened to the user account, the opening status of the third level is maintained until the functions of the third level are closed upon a request from the user account. When the user account requests to use the functions of the third level, a security verification corresponding to a privilege of using the functions of the third level is conducted. If the user account passes the security verification corresponding to the privilege of using the functions of the third level, the privilege of using the functions of the third level is opened to the user account. The privilege of using the functions of the third level is maintained to open until the user account logs off the system or the privilege of using the functions of the third level is closed to the user account.

When the privilege of using the functions of the third level is opened, if a request for setting logic of the functions of the third level for the user account is received, function logics are custom-made. After the custom-made function logics are satisfied, the functions of the third level are implemented.

The example method may also include the following characteristics. The functions of the third level may include a custom-made message reading function. If a request for setting logic of the functions of the third level for the user account is received, the function logics may include the following.

If a request for setting message reading logic for the user account is received, the message reading logic is custom-made.

After the custom-made function logics are satisfied, the functions of the third level may be implemented as follows. For example, after the message reading logic is satisfied, the message is pushed to the user account or a receiving party designated by the user account.

The example method may also include the following characteristics. The functions of the third level may include a custom-made log supervising function. If a request for setting logic of the functions of the third level for the user account is received, the function logics may include the following. If a request for setting custom-made log for the user account is received, custom-made log logic is generated based on the request for setting custom-made log. After the custom-made function logic is satisfied, the functions of the third level may be implemented as follows. The custom-made log is generated based on the custom-made log logic.

The example method may also include the following characteristics. The functions of the third level may include a mobile device remote administering function. When the mobile device remote administering function is opened to the account, a mobile device for the remote administration may be designated. If a request for setting logic of the functions of the third level for the user account is received, the function logics may include the following. If a request for setting remote administration triggering logic for the user account is received, the remote administration triggering logic is set. After the custom-made function logics are satisfied, the functions of the third level may be implemented as follows. When the remote administration triggering logic is satisfied, the designated mobile device is triggered to conduct the remote administration.

The present disclosure also provides an example apparatus for controlling accounts of an online transaction platform. The example apparatus may include a level configuring module, a level initiating module, and a level controlling module. The level configuring module provides leveled control functions to a user account. Functions provided to the user account may be classified into at least two levels. Each level may provide or include one or more functions and each level corresponds to respective security verification.

The level initiating module opens the leveled control functions to the user account or authorizes the user account.

After the level initiating module opens the leveled control functions to or authorizes the user account, when the user account is used to log in subsequently, the level controlling module receives a request for opening a level of the user account. If the user account passes a security verification corresponding to the requested level, the level controlling module opens functions of the requested level for the user account and maintains an opening status of the opened level until the user account logs off a system or the opened level is closed to the user account.

The example apparatus may further include the following characteristics. For example, the level initiating module may use the following methods to open the leveled control functions to the user account.

When the user account satisfies a first condition, after the request for opening the leveled control functions from the user account is received, the level initiation module applies a security verification corresponding to the leveled control functions to the user account. If the user account passes the security verification, the leveled control functions are opened to the user account.

The example apparatus may also include the following characteristics. The security verification corresponding to the leveled control functions may include personal information verification.

The example apparatus may also include the following characteristics. For example, the level initiating module may authorize the user account as follows.

When the user account satisfies a second condition, after a request for authorizing the user account is received, such request is forwarded to a controlling party of the user account. Security verification related information sent by the controlling party to the user account is received and such security verification related information is forwarded to the user account. Responding information relating to the security verification related information returned by the user account is received. Whether the user account passes the verification is determined based on the responding information. If the user account passes the verification, the user account is authorized.

The example apparatus may also include the following characteristics. The security verification related information may include a security question or a combination of the security question and a verification code. The responding information may include an answer to the security question or a combination of the answer to the question and the verification code.

The example apparatus may also include the following characteristics. When the level configuring module configures the levels, the levels may include a first level and a second level. The second level may be requested for initiation or opening only after the first level is initiated or opened.

When the request for log-in from the user account is received, the level controlling module applies identity verification for log-in. If the user account passes the security verification, the functions of the first level are opened to the user account. The opening status of the first level is maintained until the user account logs off the system.

When the request for opening the second level from the user account is received, security verification corresponding to the second level is conducted. If the user account passes the security verification, the functions of the second level are opened to the user account. The opening status of the second level is maintained until the user account logs off the system.

The example apparatus may also include the following characteristics. When the level configuring module configures the levels, the levels may further include a third level. The third level may be requested for opening only after the second level is opened. After functions of the third level are opened to the user account, the level controlling module may maintain the opening status of the third level until the functions of the third level are closed upon a request from the user account.

When the user account requests to use the functions of the third level, the level controlling module applies a security verification corresponding to the privilege of using the functions of the third level. If the user account passes the security verification corresponding to the privilege of using the functions of the third level, the privilege of using the functions of the third level is opened to the user account. The privilege of using the functions of the third level is maintained to open until the user account logs off the system or the privilege of using the functions of the third level is closed to the user account.

In some example embodiments, the example apparatus may further include a function implementing module. After the privilege of using the functions of the third level is opened, if a request for setting logic of the functions of the third level for the user account is received, the function implementing module sets custom-made function logics. When the custom-made function logics are satisfied, the function implementing module implements the functions of the third level.

The example apparatus may also include the following characteristics. The functions of the third level may include a custom-made message reading function. The function implement module may include a custom-made message reading sub-module. If a request for setting message reading logic for the user account is received, the custom-made message reading sub-module sets the message reading logic. After the message reading logic is satisfied, the custom-made message reading sub-module pushes the message to the user account or a receiving party designated by the user account.

The example method may also include the following characteristics. The functions of the third level may include a custom-made log supervising function. The function implementing module may include a custom-made log supervising sub-module. If a request for setting log for the user account is received, the custom-made log supervising sub-module generates a custom-made log logic based on the request for setting log and generates a custom-made log based on the custom-made log logic.

The example method may also include the following characteristics. The functions of the third level may include a mobile device remote administering function. The function implementing module may include a mobile device remote administering sub-module. If a request for setting remote administration triggering logic for the user account is received, the mobile device remote administering sub-module sets the remote administration triggering logic. When the remote administration triggering logic is satisfied, the mobile device remote administering sub-module triggers the designated mobile device to conduct the remote administration.

The present disclosure also provides an example server. The example server may include the above example apparatus for controlling accounts of the online transaction platform.

The present techniques use forms of leveled functions to flexibly grant a user of a network verification platform to control and administer the account of the user.

During one log-in, some functions only need verification once and thus the present techniques avoid verification each time and facilitate operations. The present techniques also provide message reading and log supervising functions so that the user may better understand account information and timely find abnormal information of the account.

Certainly, it is not necessary for a product of the present disclosure to achieve all of the above functionalities.

### BRIEF DESCRIPTION OF THE DRAWINGS

To better illustrate the embodiments of the present disclosure, the following is a brief introduction of the FIGs to be used in the description of the embodiments. It is apparent that the following FIGs only relate to some embodiments of the present disclosure. A person of ordinary skill in the art can obtain additional embodiments of the present invention according to the FIGs in the present disclosure without creative efforts. The example embodiments and their specifications are used to illustrate the present disclosure and shall not constitute restrictions to the present disclosure.

FIG. 1 illustrates a flow chart of an example method for opening leveled control functions to a principal account in accordance with a first example of the present disclosure.

FIG. 2 illustrates a flow chart of an example method for obtaining the leveled control functions for the principal account in accordance with the first example of the present disclosure.

FIG. 3 illustrates a flow chart of an example method for authorizing a child account in accordance with a second example of the present disclosure.

FIG. 4 illustrates a flow chart of an example method for obtaining the leveled control functions for the child account in accordance with the second example of the present disclosure.

FIG. 5 illustrates a flow chart of an example method for opening a custom-made message reading function in accordance with a third example of the present disclosure.

FIG. 6 illustrates a flow chart of an example method for opening a privilege of using the custom-made message reading function in accordance with the third example of the present disclosure.

FIG. 7 illustrates a flow chart of an example method for implementing the custom-made message reading function in accordance with the third example of the present disclosure.

FIG. 8 illustrates a flow chart of an example method for opening a custom-made log supervising function in accordance with a fourth example of the present disclosure.

FIG. 9 illustrates a flow chart of an example method for opening a privilege of using the custom-made log supervising function in accordance with the fourth example of the present disclosure.

FIG. 10 illustrates a flow chart of an example method for implementing the custom-made log supervising function in accordance with the fourth example of the present disclosure.

FIG. 11 illustrates a flow chart of an example method for opening a mobile device remote administering function in accordance with a fifth example of the present disclosure.

FIG. 12 illustrates a flow chart of an example method for implementing the mobile device remote administering function in accordance with the fifth example of the present disclosure.

FIG. 13 illustrates a diagram of an example apparatus for controlling accounts of an online transaction platform in accordance with a second example embodiment of the present disclosure.

### DETAILED DESCRIPTION

The present techniques are described in detail below by reference to the FIGS and example embodiments to illustrate purposes, technical plans, and advantages of the present disclosure. It is noted that unless there is a conflict, the example embodiments or features of the example embodiments may be referenced to each other or combined.

In addition, although the flow charts show logical sequences, in some embodiments, the illustrated or described operations may be implemented in sequences other than those in the flow charts.

The first example embodiment of the present disclosure provides an example method for controlling accounts of an online transaction platform.

Leveled control functions are provided to a user account. Functions provided to the user account are classified into at least two levels. Each level may provide or include one or more functions and each level corresponds to respective security verification.

The leveled control functions or authorizations are initiated for the user account.

When the user account is used to log in subsequently, a request for opening a level of the user account is received. If the user account passes a security verification corresponding to the requested level, functions of the requested level are opened to the user account. An opening status of the opened level is maintained until the user account logs off a system or the opened level is closed to the user account. A level is opened means that different functions of the level are opened.

In an example technical plan of this example embodiment, the leveled control function for the user account may be opened as follows.

When the user account satisfies a first condition, after the request for opening the leveled control functions from the user account is received, a security verification corresponding to the leveled control functions is applied to the user account. If the user account passes the security verification, the leveled control functions are opened to the user account.

The security verification corresponding to the leveled control functions may include personal information verification.

In an example technical plan of this example embodiment, the user account may be authorized as follows.

When the user account satisfies a second condition, after a request for authorizing the user account is received, such request is forwarded to a controlling party of the user account. Security verification related information sent by the controlling party to the user account is received and such security verification related information is forwarded to the user account. Responding information relating to the security verification related information returned by the user account is received. Whether the user account passes the verification is determined based on the responding information. If the user account passes the verification, the user account is authorized.

The first condition and the second condition may be set based upon needs. For example, the user account of the online transaction platform may include a principal account. The principal account may include one or more child accounts. Each child account may further include one or more subordinate child accounts thereunder. The principal account may satisfy the first condition and the child account may satisfy the second condition. The controlling party of the child account may be an account superior to the child account. The account superior to the child account may be the principal account or another child account that is superior to the current child account.

The security verification related information may include a security question or a combination of the security question and a verification code. The responding information may include an answer to the security question or a combination of the answer to the question and the verification code.

In an example technical plan of the example embodiment, the functions provided to the user account are classified into different levels and such levels may include a first level and a second level. The second level may be requested for initiation or opening only after the first level is initiated.

In the example technical plan, when a log-in request from the user account is received, identity verification for logging-in is conducted. If the user account passes the identity verification, the functions of the first level are opened to the user account. The opening status of the first level is maintained until the user account logs off the system.

When a request for opening the second level for the user account is received, a security verification corresponding to the second level is conducted. If the user account passes the security verification corresponding to the second level, the functions of the second level are opened to the user account. The opening status of the second level is maintained until the user account logs off the system.

For example, the first level may include functions such as log-in or instant messenger (IM) communication. The second level may include functions such as account personal information maintenance, transaction platform operation, etc. In addition to the first level and the second level, some other levels may be set and each additional level may include different functions, such as an emergency privilege restriction function, a custom-made message reading function, a custom-made log supervising function, a mobile device remote administering function. The above levels and functions at each level are for illustration only and may be set upon needs, to which the present disclosure does not impose any restriction.

In an example technical plan of the example embodiment, the levels may further include a third level. The third level may be requested for opening only after the second level is opened. For example, after functions of the third level are opened to the user account, the opening status of the third level is maintained until the functions of the third level are closed upon a request from the user account. When the user account requests to use the functions of the third level, a security verification corresponding to the privilege of using the functions of the third level is conducted. If the user account passes the security verification corresponding to the privilege of using the functions of the third level, the privilege of using the functions of the third level is opened to the user account. The privilege of using the functions of the third level is maintained to open until the user account logs off the system or the privilege of using the functions of the third level is closed to the user account.

When the privilege of using the functions of the third level is opened, if a request for setting logic of the functions of the third level for the user account is received, function logics are custom-made. After the custom-made function logics are satisfied, the functions of the third level are implemented.

The functions of the third level may include one or more of the following: a custom-made message reading function, a set logic supervising function, and a mobile device remote administering function. The third level is used herein as a general representation. For example, the custom-made message reading function, the set logic supervising function, and the mobile device remote administering function may be independent. That is, they are independent from the first level and the second level, and may locate at the third level, a fourth level, and a fifth level respectively. For another example, they may all exist at the third level. For another example, two functions may exist at the third level and another function may exist at an additional separate and independent level.

For example, the functions of the third level may include the custom-made message reading function. When a request for setting logic of the functions of the third level for the user account is received, the function logics may be set as follows. If a request for setting message reading logic for the user account is received, the message reading logic is custom-made. After the custom-made function logic is satisfied, the functions of the third level may be implemented as follows. After the message reading logic is satisfied, the message is pushed to the user account or a receiving party designated by the user account.

For another example, the functions of the third level may include the custom-made log supervising function. When a request for setting logic of the functions of the third level for the user account is received, the function logics may be set as follows. If a request for setting log for the user account is received, a custom-made log logic is generated based on the request for setting log. After the custom-made function logics are satisfied, the functions of the third level may be implemented as follows. The custom-made log is generated based on the custom-made log logic.

For another example, the functions of the third level may include the mobile device remote administering function. When the mobile device remote administering function is opened for the account, a mobile device for the remote administration may be designated. When a request for setting logic of the functions of the third level for the user account is received, the function logics may be custom-made as follows. If a request for setting remote administration triggering logic for the user account is received, the remote administration triggering logic is set. After the custom-made function logics are satisfied, the functions of the third level may be implemented as follows. When the remote administration triggering logic is satisfied, the designated mobile device is triggered to conduct the remote administering.

The example embodiment of the present disclosure also provides an example method for controlling functions. A first function is provided to the user account. When a request for opening a first function from the user account is received, if the user account passes a security verification corresponding to the first function, the first function is opened to the user account.

After the first function is opened to the user account, when the user account requests to use the first function, the security verification corresponding to a privilege of using the first function is applied. If the user account passes the security verification corresponding to the privilege of using the first function, the privilege of using the first function is opened. The opening of the privilege of using the first function is maintained until the user account logs off the system and the privilege of using the first function is closed to the user account.

After the privilege of using the first function is opened, if a request for setting logics related to first function of the user account is received, the function logics are custom-made. After the custom-made function logics are satisfied, the first function is implemented. The first function may include, but is not limited to, the custom-made message reading function, the custom-made log supervising function, or the mobile device remote administering function.

The example embodiment of the present disclosure also provides an example apparatus for controlling functions that implement the above example method for controlling functions.

The following examples or example embodiments are used to further illustrate the present disclosure. In the following example embodiments, the function levels may include the first level, the second level, and a specialized level (such as a custom-made message reading function level, a custom-made log supervising function level, or a mobile device remote administering function level). The user account may include a principal account and a child account. However, the present disclosure is not limited to such examples.

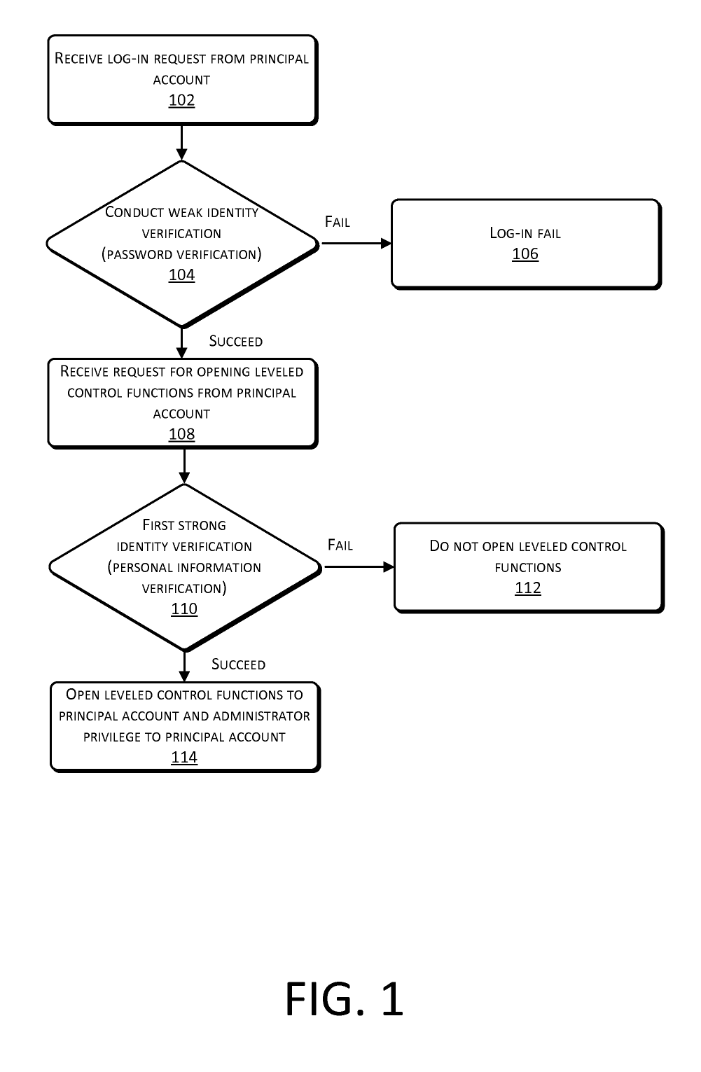

FIG. 1 illustrates a flow chart of an example of opening leveled control functions to the principal account.

At 102, a server receives a log-in request from the principal account.

At 104, the server conducts identity verification, which is referred to as weak identity verification such that a password carried in the log-in request is verified to determine whether it is correct. If the verification is successful, operations at 108 are performed. Otherwise, operations at 106 are performed.

At 106, the principal account is notified that the log-in fails.

At 108, the principal account is notified that the log-in succeeds and a request for opening leveled control functions from the principal account is received.

At 110, after receiving the request for opening leveled control functions from the principal account, the server conducts security verification corresponding to the leveled control functions, which is referred to as a first strong identity verification. The first strong identity verification may include personal information verification. If the verification fails, operations at 112 are performed. Otherwise operations at 114 are performed.

The personal information verification may include website registration, operation information verification, and cell phone short message verification.

At 112, the server does not open the leveled control functions to the principal account.

At 114, the server opens the leveled control functions to the principal account. The principal account obtains an administrator privilege. Generally, the administrator privilege includes all privileges of the principal account.

After the leveled control functions are opened, when the principal account logs in subsequently, as the functions of the principal account are leveled, the principal account needs to pass the security verification of the corresponding level to obtain the corresponding functions. Certainly, the user may apply to close the leveled control functions. When the user applies to close the leveled control functions, the user may also need to pass the first strong identity verification.

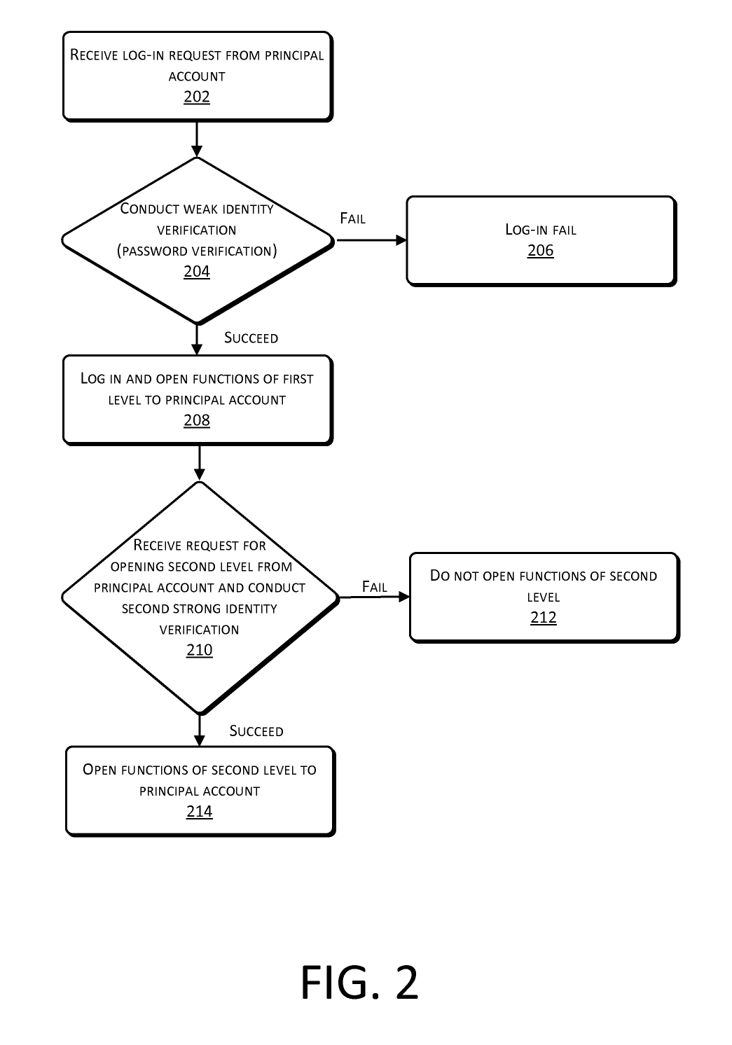

After the leveled control functions are opened to the principal account, the level management for the subsequent log-in is shown in FIG. 2.

At 202, the server receives a log-in request from the principal account.

At 204, the server conducts identity verification, which is the weak identity verification (such that the password carried in the long-in request is determined whether it is correct). If the verification is successful, operations at 208 are performed. Otherwise operations at 206 are performed.

At 206, the principal account is notified that the log-in fails.

At 208, the principal account is notified that the log-in succeeds and the functions of the first level are opened to the principal account.

At 210, the server receives a request for opening the second level from the principal account, interacts with the principal account, and conducts security verification corresponding to the second level, which is referred to as a second strong identity verification. If the verification fails, operations at 212 are performed. Otherwise, operations at 214 are performed.

The second strong identity verification may include verification methods such as the security product or short message service. Certainly, some other verification methods may be set based upon needs, to which the present disclosure does not impose any limitation.

At 212, the server does not open the functions of the second level to the principal account.

At 214, the server opens the functions of the second level to the principal account.

As shown from the above example, after the leveled control functions are opened, the functions of the principal account achieve leveled control. After the principal account successfully logs in, only the first level is opened. After the principal account passes the security verification corresponding to the second level, the functions of the second level are opened. In addition, after the functions of the second level are opened, as the functions of the second level are kept open until the principal account logs off from the current log-in or the functions of the second level are closed to the user account upon a request from the user account. Thus, after the functions of the second level are opened to the principal account, if the functions of the second level include account transaction, the principal account may directly conduct the account transaction without security verification for each transaction, which facilitates the user.

In another example technical plan of the example embodiment of the present disclosure, the principal account may authorize the child account, close the child account, or limit functions of the child account. An implementation of the authorization may be referenced to a second example below. The principal account may directly interact with the server to close the child account or limit function of the child account. After corresponding security verification is passed, the server closes relevant functions of the child account.

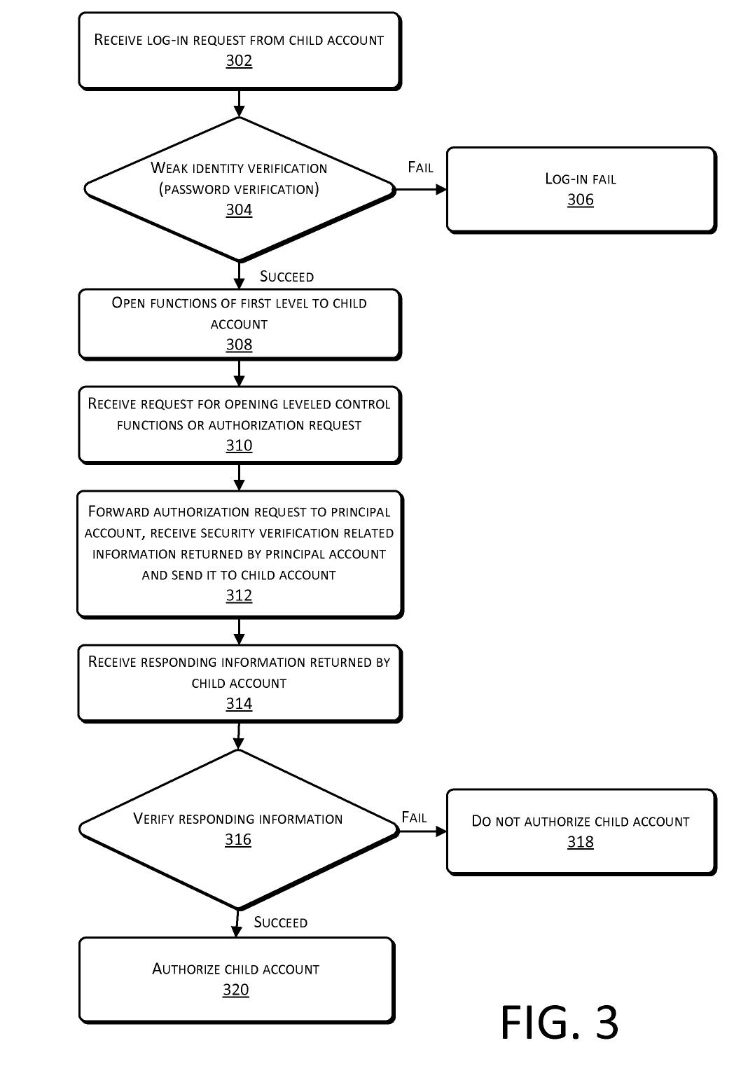

The following illustrates the second example of the present disclosure. In the example, the principal account and the child account are provided. The child account needs to obtain the authorization from the principal account to obtain the functions of the second level. FIG. 3 illustrates a flow chart of an example method for authorizing the child account.

At 302, the server receives a log-in request from the child account.

At 304, the server conducts identity verification, which is the weak identity verification (such that the password carried in the log-in request is verified whether correct). If the verification succeeds, operations at 308 are performed. Otherwise, operations at 306 are performed.

At 306, the child account is notified that the log-in fails.

At 308, the child account is notified that the log-in succeeds. The functions of the first level are opened to the child account.

At 310, a request for opening leveled control functions is received from the child account, which is equivalent to an authorizing request.

At 312, the request for opening leveled control functions is forwarded to the principal account. The security verification related information returned by the principal account is received. The security verification related information is sent to the child account.

The security verification related information may include the security question and the verification code. The verification code may be automatically generated by the system. When the principal account sets the security question, its answer is also set and saved into the system.

After the security verification, the principal account may revise the security question.

At 314, responding information corresponding to the security verification related information returned by the child account is received. For example, the responding information may include the security code and the answer to the security question. The child account may send the security code and the answer to the security question to a number designated by the system by short message service or internet protocol (IP) network.

At 316, the server verifies the responding information such as the answer and the verification code. If the verification passes, operations at 320 are performed. Otherwise, operations at 318 are performed.

At 318, the verification fails and the server does not authorize the child account.

At 320, the verification succeeds and the server authorizes the child account.

For example, a cell phone number of the child account may be stored as a cell phone for security verification. The daily verification may use the cell phone as a security trusted cell phone for the child account.

After the above operations, the child account obtains the authorization. Afterwards each verification of the child account administration (such as revising cell phone, re-authorizing) may be implemented through the same process accordingly.

In this example, the security verification method (which is the answer in addition to the verification code) that the principal account authorizes the child is just for illustration. Some other methods may be used for verification such as one or any combination of the following: the question, the security code (which may be transmitted through short message service, instant messaging (IM) tool, or any other information transmission method), and the one time password (OTP) product.

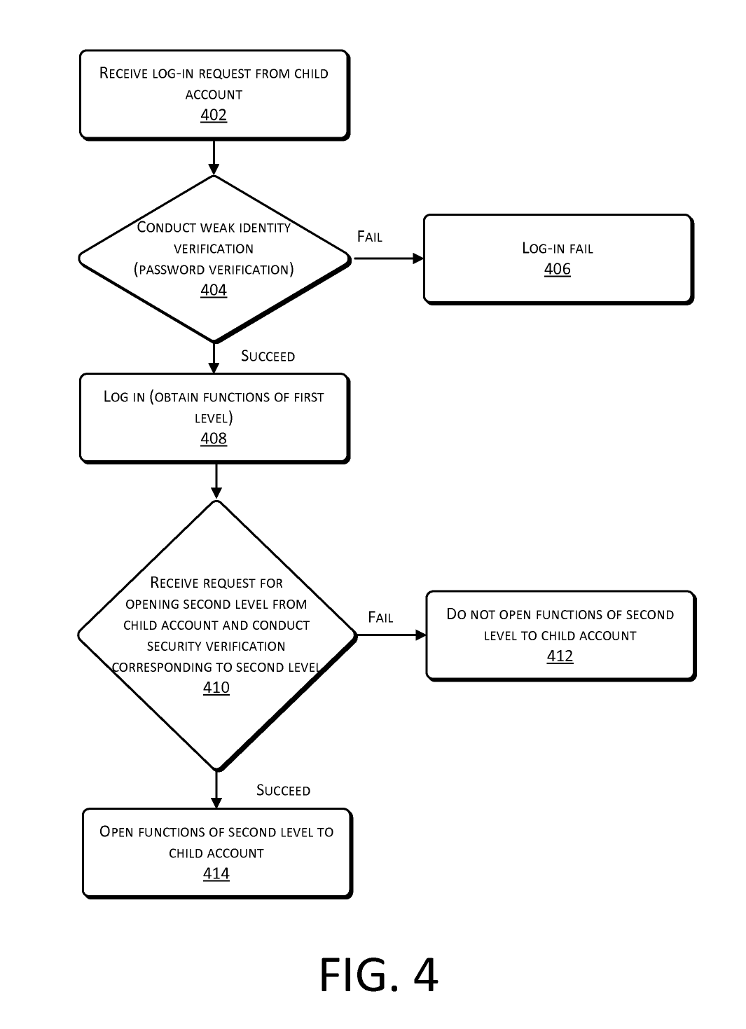

Through the above process, the child account obtains the authorization. When the child account logs in subsequently, the level controlling may be applied. After the child account is authorized by the principal account, FIG. 4 shows a flow chart of an example method for subsequent level controlling.

At 402, the server receives a log-in request from the child account.

At 404, the sever conducts the identity verification, which is the weak identity verification (such that the password carried in the log-in request is verified whether correct). If the verification succeeds, operations at 408 are performed. Otherwise, operations at 406 are performed.

At 406, the child account is notified that the log-in fails.

At 408, the child account is notified that the log-in succeeds and the functions of the first level are opened to the child account.

At 410, the server receives a request for opening functions of the second level from the child account, interacts with the child account, and conducts identity verification corresponding to the second level (such as verification through the security product or short message service). If the verification fails, operations at 412 are performed. Otherwise, operations at 414 are performed.

At 412, the server does not open the functions of the second level to the child account.

At 414, the server opens the functions of the second level to the child account.

For example, the functions of the second level provided to the child account may be different from the functions of the second level provided to the principal account.

The following illustrates a third example of the present disclosure. In this example, functions of another level independent from the first level and the second level are provided to the user account. An example custom-made message reading function is illustrated in this example. A merchant account at a company level may have onerous complicated account information. It is incapable or unnecessary for a manager of a particular business to supervise and learn all business. Thus, it is very necessary to have the custom-made message reading function. In addition, such message reading may be configured with business logic. For example, if a single transaction amount is higher than $1,000 or a particular customer's daily consumption account is higher than $5,000, a corresponding message may be sent to the user account so that the user of the user account may understand and review corresponding information.

The custom-made message reading function may be requested for opening only after the functions of the second level are opened. Before the user uses the custom-made message reading function, the custom-made message reading function needs to be opened or initiated. When the custom-made message reading function is opened, security verification corresponding to the custom-made message reading function needs to be conducted. After the custom-made message reading function is opened and before the custom-made message reading function is used, a privilege of using the custom-made message reading function needs to be opened and security verification corresponding to the privilege of using the custom-made message reading function needs to be conducted. After the security verification is passed, the privilege of using the custom-made message reading function is opened.

After the privilege of using the custom-made message reading function is opened, the server may set the message based upon a request for custom-made message from the user account, such as configuring a message reading logic. The message reading logic may determine a scenario that a relevant message is pushed to the user account. When the message reading logic is satisfied, the message is pushed to the user account.

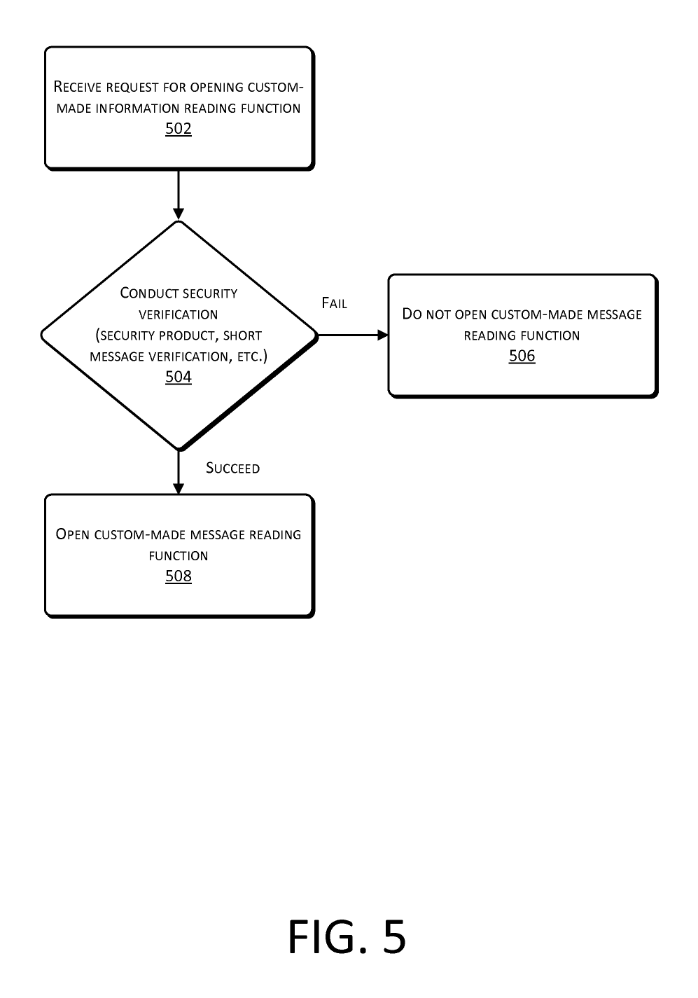

FIG. 5 shows a flow chart of an example method that the user opens the custom-made message reading function.

At 502, the server receives the request for opening the custom-made message reading function from the user account.

At 504, the server interacts with the user account and conducts security verification. The security verification may be conducted through the security product or the short message service verification. If the verification is successful, operations at 508 are performed. Otherwise, operations at 506 are performed.

At 506, the server does not open the custom-made message reading function to the user account.

At 508, the server opens the custom-made message reading function to the user account.

Through the above process, the custom-made message reading function is opened to the user account.

Different from the functions of the first level and the second level in the above examples where the user account may directly use the corresponding functions after the functions of the first level and the second level are opened, the custom-made message reading function, even after it is opened, still requires opening the privilege of using the custom-made message reading function prior to its use.

In addition, after the functions of the first level and the second level are opened, the opening time only maintains until the current log-in time of the user. When the user logs in again, if the functions of the first level and the second level need to be used, the functions of the first level and the second level need to be re-opened. After the custom-made message reading function is opened, it maintains opening status until the user account requests to close the custom-made message reading function or the server initiates to close the custom-made message reading function based on needs. The user account also needs to pass the security verification corresponding to the custom-made message reading function to close the custom-made message reading function. When the user needs to use the custom-made message reading function, the privilege of using the custom-made message reading function needs to be opened again. The privilege is maintained for opening until the current log-in ends. When the user logs in again to use the custom-made message reading function, the privilege of using the custom-made message reading function needs to be opened again. The opening and using of the following custom-made log supervising function and the mobile device remote administering function are similar to the opening and using of the custom-made message reading function.

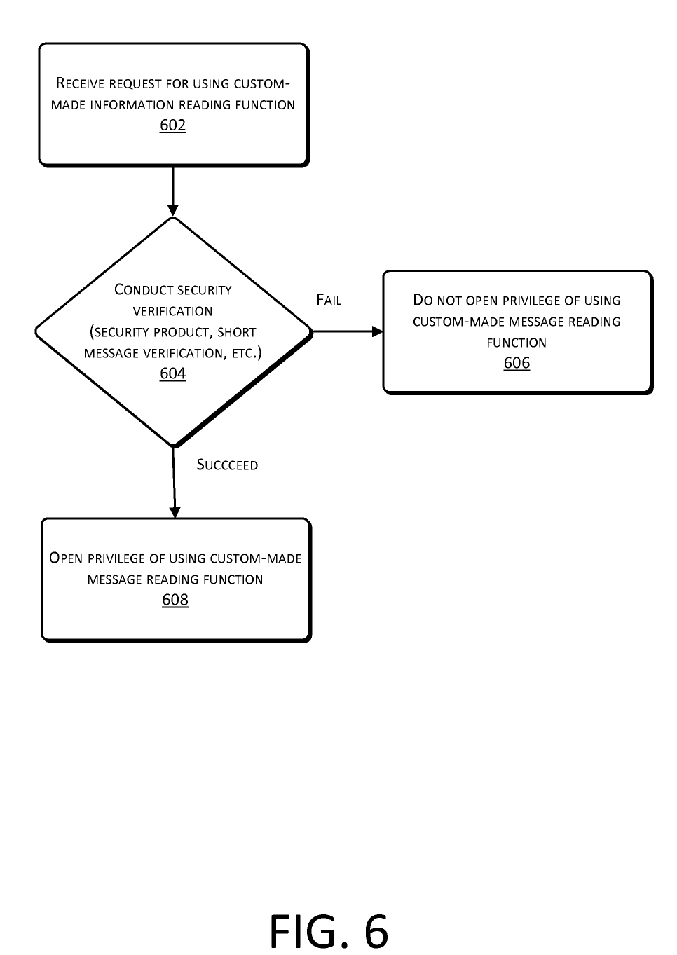

After the custom-made message reading function is opened to the user account, if the user needs to use the custom-made message reading function, the privilege of using the custom-made message reading function needs to be opened as shown in FIG. 6.

At 602, the server receives a request for using the custom-made message reading function from the user account.

At 604, the server interacts with the user account and conducts the security verification corresponding to the privilege of using opening the custom-made message reading function. The security verification may be conducted through the security product or the short message service verification. If the verification is successful, operations at 608 are performed. Otherwise, operations at 606 are performed.

At 606, the server does not open the privilege of using the custom-made message reading function to the user account.

At 608, the server opens the privilege of using the custom-made message reading function to the user account.

After the user account opens the privilege of using the custom-made message reading function, the user account may set the message reading logic (such as setting scenarios that the message needs to be pushed to the subscriber). The custom-made message reading logics may include revising, opening, and canceling message reading logic. After the message reading logic is custom-made, the message reading logic may be implemented. According to the message reading logic, the server pushes the message to the user account when the message reading logic is satisfied. The pushing method of the server may include cell phone short message service, e-mail, IM tool, and onsite mail at a website.

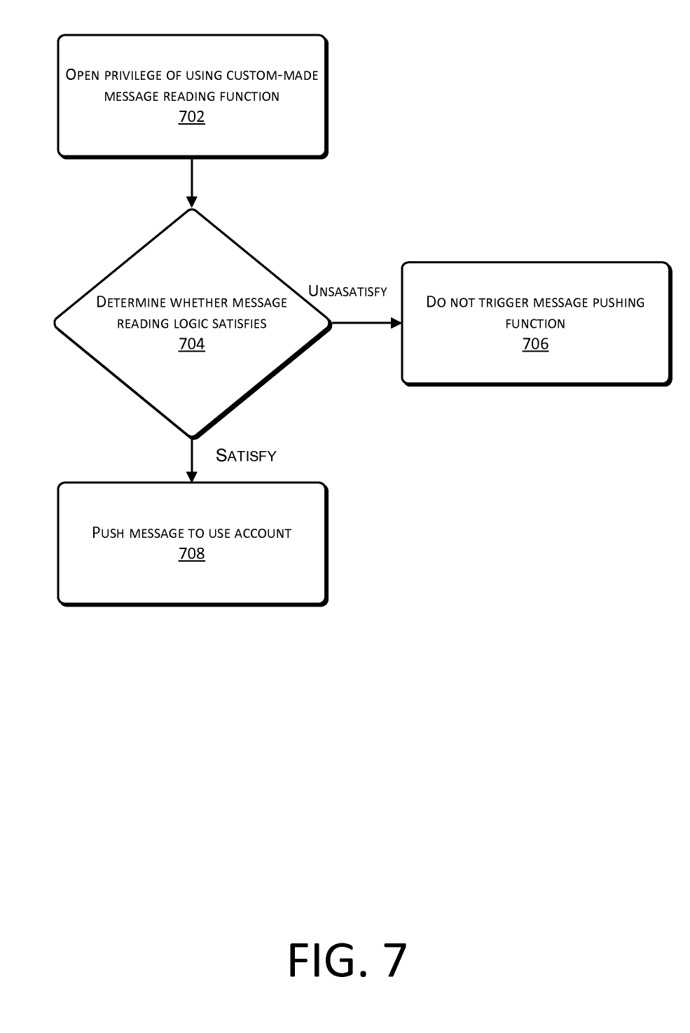

FIG. 7 illustrates a flow chart of an example method for pushing the message.

At 702, the privilege of using the custom-made message reading function is opened.

At 704, it is determined whether the message reading logic is satisfied. If the message reading logic is not satisfied, operations at 706 are performed. Otherwise, operations at 708 are performed.

At 706, the message pushing function is not triggered.

At 708, the message is pushed to the user account or the receiving party designated by the user account.

The custom-made message reading function in this example may timely inform the merchant of the conditions of some processes that he/she is concerned. For example, the merchant may set that the refund rate be reported to the merchant. If due to certain refund transaction, the refunding rate may be higher than a threshold such that the merchant cannot meet certain standards for transaction platform promotions, the merchant may pay particular attention to recent after-sale services.

The following illustrates a fourth example of this example embodiment. In this example, the custom-made log supervising function is provided to the user account. Some merchants need to know details and conduct data mining of the logs of their accounts, such as a log-in log, a transaction log, a customer service work log, a product administration log, a shop administration log, an IM tool log, to optimize the working process efficiency and conduct secured supervision. Thus, it is necessary to have an integrated custom-made log supervising function.

The custom-made log supervising function may be opened only after the functions of the second level are opened. Before the user uses the custom-made log supervising function, the custom-made log supervising function needs to be opened or initiated. After the custom-made log supervising function is opened, before the custom-made log supervising function is used, a privilege of using the custom-made log supervising function needs to be opened and security verification corresponding to the privilege of using the custom-made log supervising function needs to be conducted. After the security verification is passed, the privilege of using the custom-made log supervising function is opened.

After the privilege of using the custom-made log supervising function is opened, the user account may conduct custom-made log. For example, the user account may be used to set custom-made logs such as the log-in log, the transaction log, the customer service work log, the product administration log, etc. The user account may also be used to view the logs. After the server receives the request for custom-made log from the user account, the server generates the custom-made log logic and the custom-made log based on the custom-made log logic. In addition, the server, after receiving the viewing request from the user account, displays the requested log to the user account.

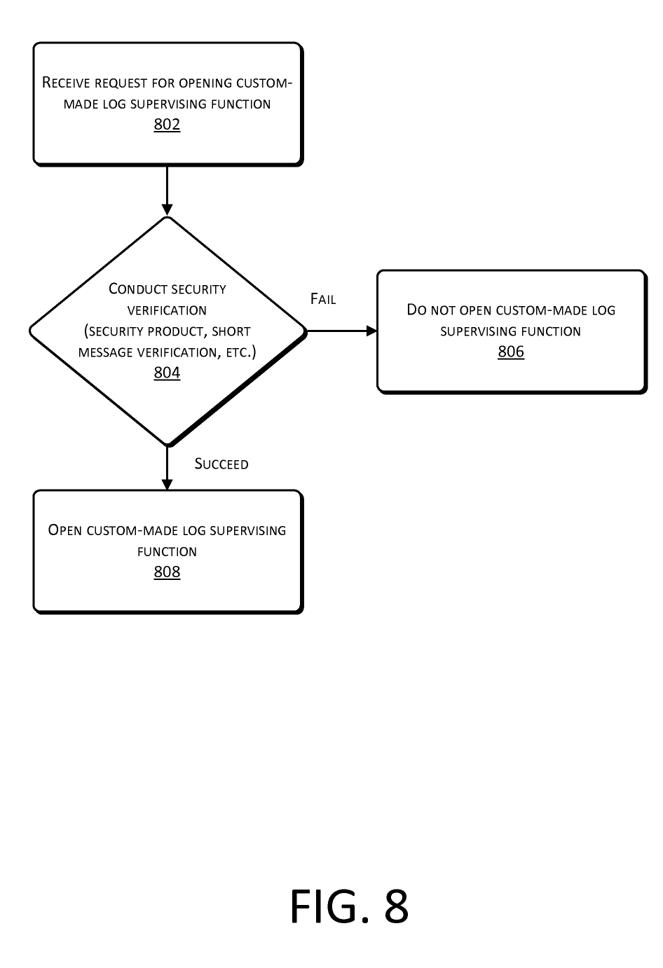

FIG. 8 illustrates a flow chart of an example method for opening the custom-made log supervising function.

At 802, the server receives the request for opening the custom-made log supervising function from the user account.

At 804, the server interacts with the user account and conducts the security verification corresponding to the custom-made log supervising function. The security verification may be conducted through the security product or the short message service verification. If the verification is successful, operations at 808 are performed. Otherwise, operations at 806 are performed.

At 806, the server does not open the custom-made log supervising function to the user account.

At 808, the sever opens the custom-made log supervising function to the user account.

Through the above process, the custom-made log supervising function is opened to the user account. For example, after the custom-made log supervising function is opened, it remains opening status until a request for closing the custom-made log supervising function is received from the client. After such request passes the security verification of the custom-made log supervising function, the custom-made log supervising function is closed.

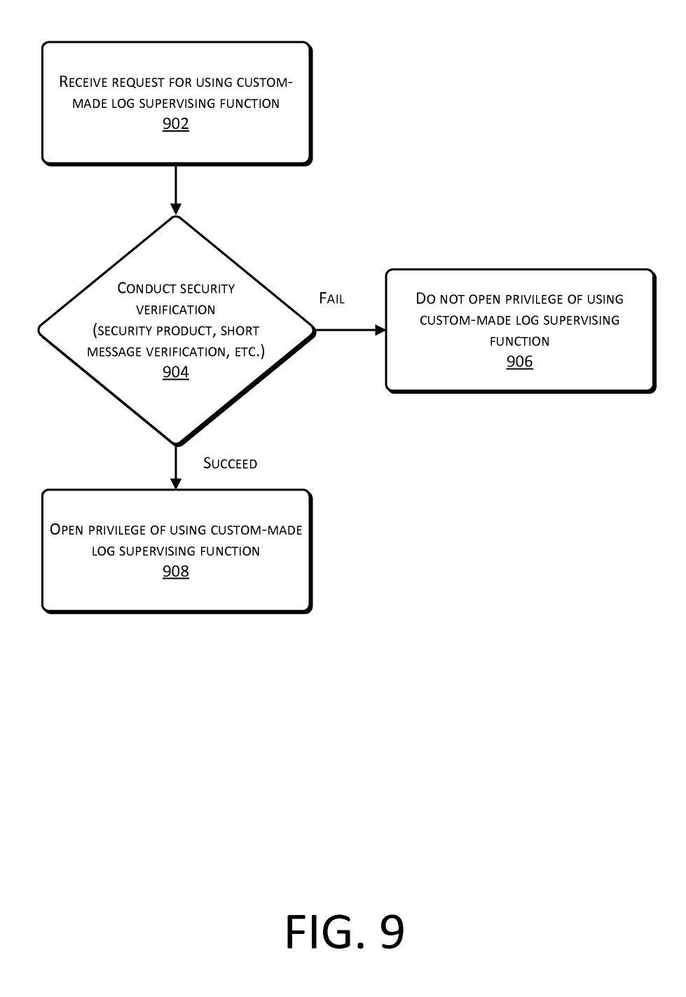

After the custom-made log supervising function is opened to the user account, if the user needs to use the custom-made log supervising function, the privilege of using the custom-made log supervising function needs to be opened. FIG. 9 illustrates a flow chart of an example method for opening the privilege of using the custom-made log supervising function.

At 902, the server receives a request for using the custom-made log supervising function from the user account.

At 904, the server interacts with the user account and conducts the security verification corresponding to the privilege of using the custom-made log supervising function. The security verification may be conducted through the security product or the short message service verification. If the verification is successful, operations at 908 are performed. Otherwise, operations at 906 are performed.

At 906, the server does not open the privilege of using the custom-made log supervising function to the user account.

At 908, the server opens the privilege of using the custom-made log supervising function to the user account.

After the privilege of using the custom-made log supervising function is opened to the user account, the user account may be used to set the custom-made log or view the log.

The custom-made log supervising function may be used to effectively collect evidences to facilitate secured management and optimize the operation process. For example, a merchant may have three after-sale service representatives, i.e., A, B, and C, who are responsible for the same work. If a particular transaction causes loss to the merchant due to improper behavior of an employee, there is a need to find who is responsible and what the employee does through legal approach. The log supervision may become the indispensable evidence.

The following illustrates a fifth example of this example embodiment. In this example, the user account is provided with the mobile device remote administering function.

The mobile device remote administering function may be opened only after the functions of the second level are opened. Before the user uses the mobile device remote administering function, the mobile device remote administering function needs to be opened or initiated. After the mobile device remote administering function is opened and before the mobile device remote administering function is used, a privilege of using the mobile device remote administering function needs to be opened and security verification corresponding to the privilege of using the mobile device remote administering function needs to be conducted. After the security verification is passed, the privilege of using the mobile device remote administering function is opened.

After the privilege of using the mobile device remote administering function is opened, the remote administering triggering logic may be set according to the request for setting the remote administering triggering logic from the user account. After the request for triggering remote administering is received from the user account, whether the remote administration triggering logic is satisfied is determined If the remote administration triggering logic is satisfied, the designated mobile device is triggered to conduct the remote administration.

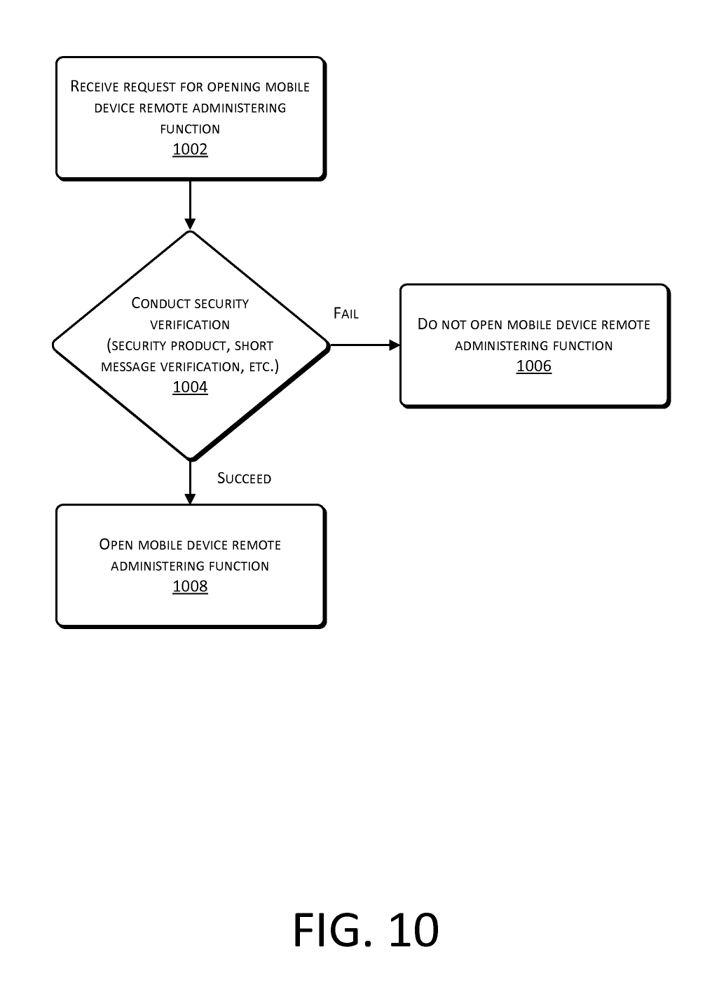

FIG. 10 illustrates a flow chart of an example method for opening the mobile device remote administering function.

At 1002, the server receives the request for opening the mobile device remote administering function from the user account.

At 1004, the server interacts with the user account and conducts the security verification corresponding to the mobile device remote administering function. The security verification may be conducted through the security product or the short message service verification. If the verification is successful, operations at 1008 are performed. Otherwise, operations at 1006 are performed.

At 1006, the server does not open the mobile device remote administering function to the user account.

At 1008, the server opens the mobile device remote administering function to the user account.

Through the above process, the mobile device remote administering function is opened to the user account.

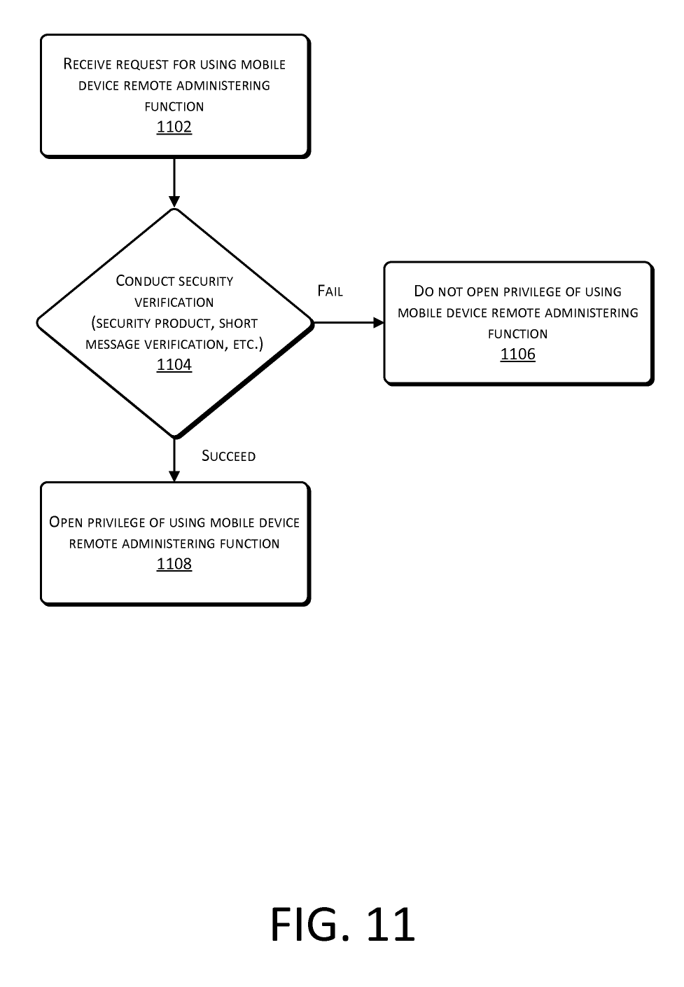

After the mobile device remote administering function is opened to the user account, if the user needs to use the mobile device remote administering function, the privilege of using the mobile device remote administering function needs to be opened. FIG. 11 illustrates a flow chart of an example method for opening the privilege of using the mobile device remote administering function.

At 1102, the server receives a request for using the mobile device remote administering function from the user account.

At 1104, the server interacts with the user account and conducts the security verification corresponding to the privilege of using the mobile device remote administering function. The security verification may be conducted through the security product or the short message service verification. If the verification is successful, operations at 1108 are performed. Otherwise, operations at 1106 are performed.

At 1106, the server does not open the privilege of using the mobile device remote administering function to the user account.

At 1108, the server opens the privilege of using the mobile device remote administering function to the user account.

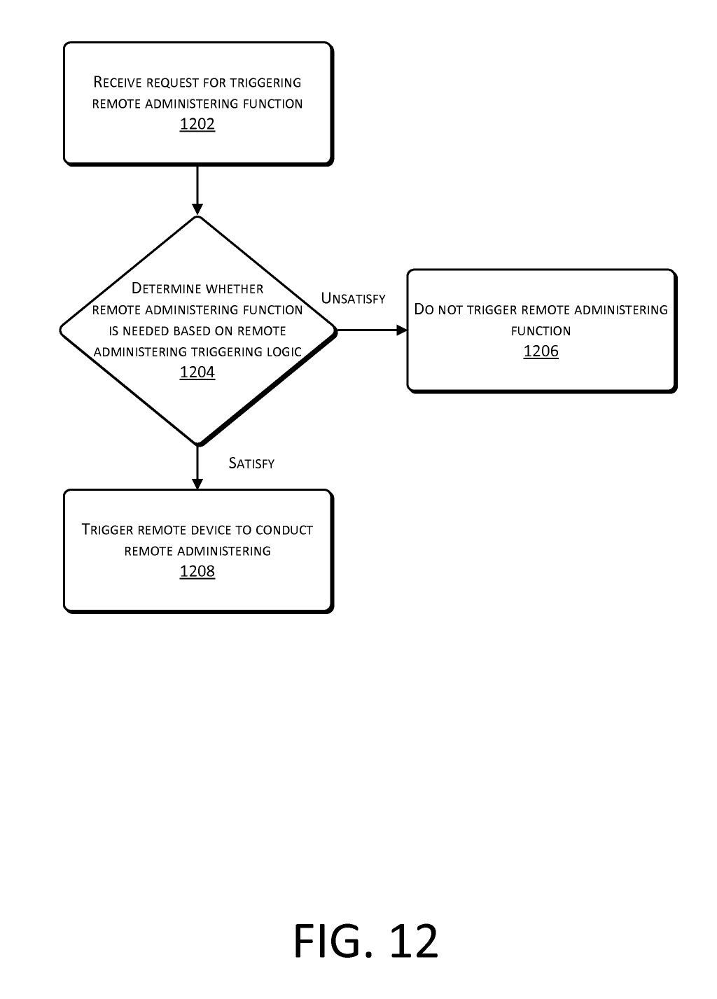

After the privilege of using the mobile device remote administering function is opened to the user account, the remote administering triggering logic may be set based upon the request for setting by the user. After the request for triggering the remote administering is received, whether the remote administering triggering logic is satisfied is determined. If the remote administering triggering logic is satisfied, the designated mobile device is triggered to conduct remote administering. FIG. 12 illustrates a flow chart of an example method for triggering the designated mobile device to conduct remote administering.

At 1202, the server receives the request for triggering remote administering.

At 1204, the server determines whether to trigger the remote administering based on the set remote administering triggering logic. If a determining result is not in compliance with the remote administering triggering logic, operations at 1206 are performed. If the determining result is in compliance with the remote administering triggering logic, operations at 1208 are performed.

At 1206, the remote administering function is not triggered.

At 1208, the mobile device is triggered to conduct the remote administering.

Controlling methods for the remote administering may include a mobile device software network control, a cell phone short message verification code control, etc.

Through the mobile device remote administering function, the user may conduct emergent operation administration of his/her account timely. Operation controls of some special accounts of the merchant have real-time characteristics. Such operation controls may include a privilege approval, a business process approval, an account privilege emergent control, etc. Thus, the portable mobile device (such as the cell phone or the tablet) may satisfy the real-time characteristic of software administration. The mobile device remote administering function may be used to conduct account operations that have high requirements for importance and timeliness. For example, when a financial representative wants to transfer $10,000, such operation needs an approval by a manager. However, the manager is on business travel and cannot immediately operate a computer. Then the mobile device remote administering function may be used to complete the transfer.

For example, the remote administering triggering logic may be that the account is locked when a refunding operation is initiated through an unregistered location. After the mobile device remote administering function and the privilege of using the mobile device remote administering function are opened, the mobile device initiate a request for locking the account. The server determines whether the remote administering triggering logic applies. If the server detects that the refunding operation is initiated through the unregistered location, the triggering logic applies and triggers the mobile device for remote administering to lock the account.

For another example, the remote administering triggering logic may be that the account is locked and cannot be operated when a transaction commission is changed to be higher than a threshold (such as 50%).

The various functions from the above third example to the fifth example may only need to be opened once. Such functions maintain opening status until such functions are closed. A lasting time of the privilege of using each function may be the current log-in time of the user account. When the user account logs in again, the privilege of using each function needs to be re-obtained.

The emergent privilege restricting function is briefly discussed below. Similar to the above message reading function, the custom-made log supervising function, and the mobile device remote administering function, the emergent privilege restricting function needs to be opened. Then the privilege of using the emergent privilege restricting function needs to be opened to set corresponding logic. The emergent privilege restricting function is implemented based on the set logic. For example, if the user of the principal account finds that its account is hacked, the user of the principal account may use the authorized emergent privilege restricting function to freeze all functions of the account such that the account may temporarily lose the functions of the first level, the functions of the second level, or any other function.

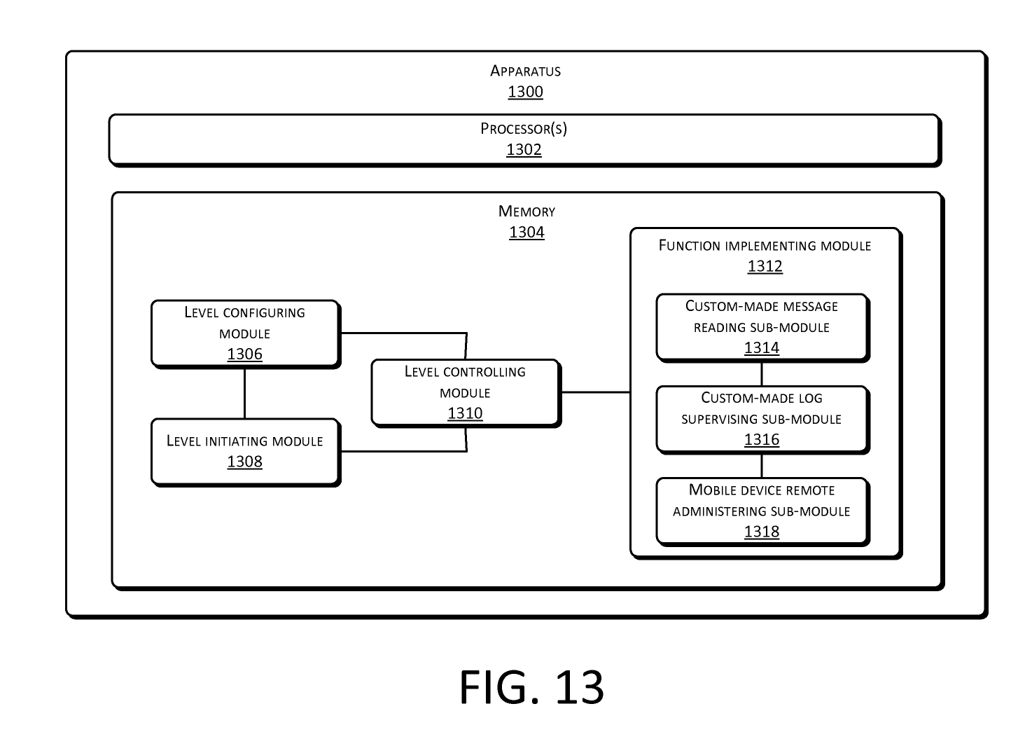

The second example embodiment of the present disclosure provides an example apparatus for controlling accounts of online transaction platform. FIG. 13 illustrates a diagram of an example apparatus 1300 for controlling accounts of online transaction platform.

The apparatus 1300 may include one or more processor(s) 1302 and memory 1304. The memory 1304 is an example of computer-readable media. As used herein, “computer-readable media” includes computer storage media and communication media.

Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 1304 may store therein program units or modules and program data.

In the example of FIG. 13, the memory 1304 may store therein a level configuring module 1306, a level initiating module 1308, and a level controlling module 1310. The level configuring module 1306 provides leveled control functions to a user account. Functions provided to the user account may be classified into at least two levels. Each level may provide or include one or more functions and each level corresponds to respective security verification.

The level initiating module 1308 opens the leveled control functions for the user account or authorizes the user account.

After the level initiating module 1308 opens the leveled control functions or authorizes the user account, when the user account is used to log-in subsequently, the level controlling module 1310 receives a request for opening a level of the user account. If the user account passes a security verification corresponding to the requested level, the level controlling module 1310 opens functions of the requested level to the user account and maintains an opening status of the opened level until the user account logs off a system or the opened level is closed to the user account.

The example apparatus 1300 may further include the following characteristics. For example, the level initiating module 1308 may use the following methods to open the leveled control functions to the user account.

When the user account satisfies a first condition, after the request for opening the leveled control functions from the user account is received, the level initiation module 1308 applies the security verification corresponding to the leveled control functions to the user account. If the user account passes the security verification, the leveled control functions are opened to the user account.

For instance, the security verification corresponding to the leveled control function may include personal information verification.

For another example, the level initiating module 1308 may authorize the user account as follows.

When the user account satisfies a second condition, after a request for authorizing the user account is received, such request is forwarded to a controlling party of the user account. Security verification related information sent by the controlling party to the user account is received and such security verification related information is forwarded to the user account. Responding information relating to the security verification related information returned by the user account is received. Whether the user account passes the verification is determined based on the responding information. If the user account passes the verification, the user account is authorized.

For instance, the security verification related information may include a security question or a combination of the security question and a verification code. The responding information may include an answer to the security question or a combination of the answer to the security question and the verification code.

For example, when the level configuring module 1306 configures the levels, the levels may include at least a first level and a second level. The second level may be requested for initiation or opening only after the first level is initiated or opened.

When the request for log-in from the user account is received, the level controlling module 1310 applies identity verification for log-in. If the user account passes the security verification, functions of the first level are opened to the user account. The opening status of the first level is maintained until the user account logs off the system.

When the request for opening the second level from the user account is received, security verification corresponding to the second level is conducted. If the user account passes the security verification, functions of the second level are opened to the user account. The opening status of the second level is maintained until the user account logs off the system.

For example, when the level configuring module 1306 configures the levels, the levels may further include a third level. The third level may be requested for opening only after the second level is opened. After functions of the third level are opened to the user account, the level controlling module 1310 may maintain the opening status of the third level until the functions of the third level are closed upon a request from the user account.

When the user account requests to use the functions of the third level, the level controlling module 1310 applies a security verification corresponding to the privilege of using the functions of the third level. If the user account passes the security verification corresponding to privileges of using the functions of the third level, the privilege of using the functions of the third level is opened to the user account. The privilege of using the functions of the third level is maintained to open until the user account logs off the system or the privilege of using the functions of the third level is closed to the user account.

In some example embodiments, the apparatus 1300 may further include a function implementing module 1312. After the privilege of using the functions of the third level is opened, if a request for setting logics of the functions of the third level is received from the user account, the function implementing module 1312 sets the function logics. When the custom-made function logics are satisfied, the function implementing module 1312 implements the functions of the third level.

For examples, the functions of the third level may include a custom-made message reading function. The function implement module 1312 may include a custom-made message reading sub-module 1314. If a request for setting message reading logic for the user account is received, the custom-made message reading sub-module 1314 sets the message reading logic. After the message reading logic is satisfied, the custom-made message reading sub-module 1314 pushes the message to the user account or a receiving party designated by the user account.

For another example, the functions of the third level may include a custom-made log supervising function. The function implementing module 1312 may include a custom-made log supervising sub-module 1316. If a request for setting log for the user account is received, the custom-made log supervising sub-module 1316 generates a custom-made log logic based on the request for setting log and a log based on the custom-made log logic.

For another example, the functions of the third level may include a mobile device remote administering function. When the level controlling module 1310 opens the mobile device remote administering function to the user account, the level controlling module 1310 also designates the mobile device for remote administering.

The function implementing module 1312 may include a mobile device remote administering sub-module 1318. If a request for setting the remote administration triggering logic for the user account is received, the mobile device remote administering sub-module 1318 sets the remote administration triggering logic. When the remote administration triggering logic is satisfied, the mobile device remote administering sub-module 1318 triggers the designated mobile device to conduct the remote administering.

The present disclosure also provides an example server. The server may include the above example apparatus for controlling accounts of an online transaction platform.

The present techniques may be implemented through webpage operations. The webpage operations may be dependent on some security products (such as a digital certificate, an OTP product, a cell phone short message, a password security card, etc.) For example, the webpage operations may also rely on a secured client terminal product and only need initial verification through the cell phone short message. The secured log-in and secured forwarding after the secured log-in may be fully dependent on the verification at the secured client terminal. For example, the secured client terminal may be in the form of a personal computer or a mobile device (such as the cell phone or the tablet) by combination of computer software and hardware as the sole verification. If the user passes initial trust verification, the computer or the mobile device where the client terminal locates is treated as a trusted environment and a trust signal for secured log-in.

One of ordinary skill in the art would understand that some or all of the operations in the above methods may be implemented through computer-readable instructions to instruct hardware to accomplish. The computer-readable instructions may be stored in computer storage media such as ROM, hard disk, or CD. Alternatively, some or all of the operations in the above example embodiments may be implemented by using one or more integrated circuits. Correspondingly, each module or unit in the above example embodiments may be implemented in the form of hardware or software function module. The present disclosure does not restrict combination of any specific hardware and software.

What is claimed is:

1. A method comprising:
providing leveled control functions to a user account, the providing including classifying functions provided to the user account into at least two levels, each level including one or more functions, each level corresponding to a security verification; and
authorizing the user account.

2. The method as recited in claim 1, further comprising:
receiving a request for opening a respective level from the user account;
determining that the user account passes a respective security verification corresponding to the respective level; and
opening one or more functions of the respective level to the user account.

3. The method as recited in claim 2, further comprising:
maintaining an opening status of an opened level until the user account logs off or the opened level is closed to the user account.

4. The method as recited in claim 1, wherein the providing leveled control functions to the user account comprises:
receiving a request for opening the leveled control functions from the user account;
determining that the user account satisfies a first condition;
determining that the user account passes a security verification corresponding to the leveled control function; and
opening the leveled control functions to the user account.

5. The method as recited in claim 4, wherein the security verification corresponding to the leveled control functions includes personal information verification.

6. The method as recited in claim 1, wherein the authorizing the user account comprises:
receiving a request for authorizing from the user account;
determining that the user account satisfies a second condition;
forwarding the request for authorizing to a controlling party of the user account;
receiving security verification related information sent by the controlling party;
forwarding the security verification related information to the user account;
receiving responding information corresponding to the security verification related information from the user account;
determining that the user account passes the security verification based on the responding information; and
authorizing the user account.

7. The method as recited in claim 6, wherein:
the security verification related information includes a security question or a combination of the security question and a verification code; and
the responding information corresponding to the security verification related information includes an answer to the security question or a combination of the answer to the security question and the verification code.

8. The method as recited in claim 1, wherein the at least two levels include a first level and a second level and the method further comprises allowing a request for opening the second level from the user account only after the first level is opened to the user account.

9. The method as recited in claim 8, further comprising:
receiving a log-in request from the user account;
conducting an identity verification corresponding to the first level when the user account logs in;
determining that the user account passes the identity verification;
opening one or more functions of the first level to the user account;
maintaining an opening status of the first level for the user account until the user account logs off;
receiving a request for opening a second level from the user account;
conducting an identity verification corresponding to the second level;
determining that the user account passes the identity verification corresponding to the second level;
opening one or more functions of the second level to the user account; and
maintaining an opening status of the second level for the user account until the user account logs off

10. The method as recited in claim 8, the at least two levels further include a third level and the method further comprises allowing a request for opening the third level from the user account only after the second level is opened to the user account.

11. The method as recited in claim 10, further comprising:
receiving a request for opening a third level from the user account;
conducting an identity verification corresponding to the third level;
determining that the user account passes the identity verification corresponding to the third level;
opening a privilege of using one or more functions of the third level to the user account; and
maintaining an opening status of the privilege of using the one or more functions of the third level for the user account until the user account logs off or the privilege of using the one or more functions of the third level is closed to the user account.

12. The method as recited in claim 11, further comprising:
after the privilege of using the one or more functions of the third level is opened to the user account, receiving a request for setting a logic of the one or more functions of the third level from the user account;
setting the logic of the one or more functions;
determining that the logic of the one or more functions satisfies; and
implementing the one or more functions of the third level.

13. The method as recited in claim 10, wherein the third level provides or includes a custom-made message reading function and the method further comprises:
receiving a request for setting a message reading logic from the user account;
setting the message reading logic;
determining that the message reading logic satisfies; and
pushing a message to the user account or a receiving party designated by the user account.

14. The method as recited in claim 10, wherein the third level provides or includes a custom-made log supervising function and the method further comprises:
receiving a request for setting log from the user account;
generating a custom-made log logic according to the request for setting log;
determining that the custom-made log logic is satisfied; and
generating a log according to the custom-made log logic.

15. The method as recited in claim 10, wherein the third level provides or includes a mobile device remote administering function and the method further comprises:
when opening the mobile device remote administering function to the user account, designating a mobile device for remote administering;
receiving a request for setting a remoter administering triggering logic from the user account;
setting the remote administering triggering logic;
determining that the remote administering triggering logic is satisfied; and
triggering the designated mobile device to conduct remote administering.

16. An apparatus comprising:
a level configuring module that provides leveled control functions to a user account and classifies the functions into at least two levels, each level including one or more functions and each level corresponds to a respective security verification;
a level initiating module that opens the leveled control functions to the user account or authorizes the user account; and
a level controlling module, after the level initiating module opens the leveled control functions or authorizes the user account, when the user account is used to log-in subsequently, receives a request for opening a respective level from the user account, determines that the user account passes a security verification corresponding to the respective level, opens functions of the requested level to the user account, and maintains an opening status of the opened level until the user account logs off or the opened level is closed to the user account.

17. The apparatus as recited in claim 16, wherein:
the level configuring module classified the levels into a first level and a second level; and
the level controlling module, when receiving a log-in request from the user account, applies an identity verification for log-in, opens one or more functions of the first level to the user account in response to determining that the user account passes the identity verification for log-in, and maintains an opening status of the first level until the user account logs off; and
the level controlling module further, when receiving a request for opening the second level from the user account, conducts a security verification corresponding to the second level, opens one or more functions of the second level to the user account in response to determining that the user account passes the identity verification corresponding to the second level, and maintains an opening status of the second level until the user account logs off

18. The apparatus as recited in claim 16, wherein:
the level configuring module classifies the levels into a first level, a second level; and a third level; and
the level controlling module further receives a request for opening a third level from the user account, conducts an identity verification corresponding to the third level, determines that the user account passes the identity verification corresponding to the third level, opens a privilege of using one or more functions of the third level to the user account, and maintains an opening status of the privilege of using the one or more functions of the third level to the user account until the user account logs off or the privilege of using the one or more functions of the third level is closed to the user account.

19. The apparatus as recited in claim 18, further comprising a function implementing module that, after the privilege of using the one or more functions of the third level is opened, receives a request for setting a custom-made logic of the one or more functions of the third level from the user account, sets one or more function logics, and implements the one or more functions of the third level when the custom-made function logics are satisfied.

20. A server comprising:
an apparatus comprising:
a level configuring module that provides leveled control functions to a user account and classifies the functions into at least two levels, each level including one or more functions and each level corresponds to a respective security verification;
a level initiating module that opens the leveled control functions to the user account or authorizes the user account; and
a level controlling module, after the level initiating module opens the leveled control functions or authorizes the user account, when the user account is used to log-in subsequently, receives a request for opening a respective level from the user account, determines that the user account passes a security verification corresponding to the respective level, opens functions of the requested level to the user account, and maintains an opening status of the opened level until the user account logs off or the opened level is closed to the user account.
